(19) United States
(12) Patent Application Publication
(10) Pub. No.: US 2011/0003073 A1
(43) Pub. Date: Jan. 6, 2011

(54) METHODS FOR FORMING PIEZOELECTRIC THIN FILM, MANUFACTURING LIQUID EJECTION HEAD AND MANUFACTURING LIQUID EJECTING APPARATUS

(75) Inventor: Motohisa NOGUCHI, Suwa-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/829,970

(22) Filed: Jul. 2, 2010

(30) Foreign Application Priority Data
Jul. 6, 2009 (JP) 2009-159555

(51) Int. Cl. B05D 5/12

(52) U.S. Cl. 427/100

(57) ABSTRACT

A method for forming a piezoelectric thin film includes applying a colloid solution onto a substrate, forming a dried film by drying the colloid solution, forming an inorganic film by degreasing the dried film, and crystallizing the inorganic film. The colloid solution contains lead acetate as a material of lead oxide, an organic metal compound as a material of metal oxides other than lead oxide, a carboxylic acid, and polyethylene glycol.

This application claims a priority to Japanese Patent Application No. 2009-159555 filed on Jul. 6, 2009 which is hereby expressly incorporated by reference herein in its entirety.

### BACKGROUND

1. Technical Field

The present invention relates to methods for forming a piezoelectric thin film, manufacturing a liquid ejection head, and manufacturing a liquid ejecting apparatus.

2. Related Art

Piezoelectric thin films containing crystals represented by lead zirconate titanate (PZT) can spontaneously polarized and have high dielectric constants, electrooptic effect, piezoelectric effect, pyroelectric effect and so forth. Accordingly, they have been applied to a variety of devices such as piezoelectric elements. Such a piezoelectric thin film may be formed by, for example, metal organic deposition (MOD), sol-gel methods, chemical vapor deposition (CVD), or sputtering. In particular, wet processes such as MOD and sol-gel methods can simply produce a piezoelectric thin film at a low cost.

In a MOD process, for example, an organic metal compound, such as metal alkoxide or an acetylacetonato complex, is dissolved in a cellosolve solvent or an alcohol solvent, and a stabilizing agent, such as acetyl acetone or alkanolamine, is added to the solution to prepare a colloid solution. Subsequently, the colloid solution is applied onto an object and dried, thus forming a piezoelectric thin film.

In a sol-gel method, for example, an organic metal compound dissolved in a cellosolve solvent or an alcohol solvent is hydrolyzed to prepare a colloid solution. Subsequently, the colloid solution is applied onto an object and dried, thus forming a piezoelectric thin film.

From the viewpoint of improving the dispersion stability of acetylacetonato complex, a composition containing acetic acid and its preparation method have been known for forming piezoelectric thin films. Also, there are known a piezoelectric thin film formed of a composition containing acetic acid and a liquid ejection head including the piezoelectric thin film (for example, JA-A-2007-145657).

If the piezoelectric thin film formed by a sequence of the steps of applying a colloid solution to form a coating and drying and firing the coating has a small thickness, the sequence is repeated to obtain a thickness sufficient to function as desired. In order to increase the thickness of a film formed by a single sequence of the steps, the concentration of the organic metal compound can be increased in the colloid solution.

On the other hand, the colloid solution generally contains a stabilizing agent and other additives in addition to the solvent. This makes it difficult to increase the concentration of the organic metal compound in the colloid solution because of the following reasons.

If the content of the stabilizing agent is reduced, water in the atmosphere promotes a hydrolysis to degrade the storage stability of the colloid solution. In contrast, if the content of the solvent is reduced, the organic metal compound is chelated to precipitate. It becomes thus difficult to form a uniform film. The precipitation increases the viscosity and results in a non-uniform coating. Hence, if the content of the stabilizing agent or the solvent is reduced to increase the concentration of the organic metal compound, the above problems can occur. It is difficult to increase the thickness of a film formed by a single sequence of the steps. Accordingly, the number of sequences repeated is increased to reduce the productivity, and it is difficult to reduce the manufacturing cost.

### SUMMARY

Accordingly, an advantage of some aspects of the invention is to solve the above problems, and the invention can be achieved by the following embodiments.

According to an aspect of the invention, a method for forming a piezoelectric thin film is provided which includes applying a colloid solution onto a substrate, forming a dried film by drying the colloid solution, forming an inorganic film by degreasing the dried film, and crystallizing the inorganic film. The colloid solution contains lead acetate as a material of lead oxide, an organic metal compound as a material of metal oxides other than lead oxide, a carboxylic acid, and polyethylene glycol.

The carboxylic acid doubles as a solvent and a stabilizing agent. Accordingly, the ratio of the solvent or carboxylic acid to lead acetate and organic metal compound can be reduced to increase the concentration of the lead acetate and organic metal compound in the colloid solution. The high-concentration colloid solution can form a thick coating film through a sequence of the steps of applying the colloid solution, forming a dried film by drying the colloid solution, forming an inorganic film by degreasing the dried film, and crystallizing the inorganic film. Accordingly, the number of sequences of the steps for forming a piezoelectric thin film having a desired thickness can be reduced, and the productivity can thus be increased. Thus, the piezoelectric thin film can be formed at a low cost.

The desired thickness mentioned herein is larger than the thickness of the film formed by a single sequence of the steps, and is so large as to function as a piezoelectric thin film, depending on the required characteristics.

The organic metal compound may be a metal alkoxide.

Metal alkoxide is soluble in carboxylic acid, and this solution can be applied to form a coating. The carboxylic acid can coordinate to the metallic element of the metal alkoxide to exhibit a stabilization effect. Accordingly, a metal oxide coating can easily be formed. In addition, a solution of lead acetate and an alkoxide of a metal other than lead acetate in a carboxylic acid can easily produce a complex metal oxide containing lead.

The metal alkoxide may contain at least one of Ti and Zr. This process can easily form a PZT thin film at a low cost.

The carboxylic acid may be at least one selected from the group consisting of acetic acid, propionic acid and butyric acid.

Acetic acid, propionic acid, and butyric acid, have high solubilities in water, and accordingly can prevent the production of hydrolysates. Also, the use of these carboxylic acids allows easy coating and rapid dry because of their low viscosities and low boiling points. Accordingly, the resulting piezoelectric thin film can have a larger thickness. Thus, the number of sequences of the steps for forming a film having a desired thickness can be further reduced, and consequently, the piezoelectric thin film can be formed at a low cost. However, the use of a carboxylic acid having more carbons than butyric acid cannot ensure the colloid solution is sufficiently stable to water in the atmosphere because the solubilities of such carboxylic acids in water are low.

According to another aspect of the invention, a method is provided which manufactures a liquid ejection head including a nozzle plate having a nozzle aperture, a flow channel substrate having a pressure generating chamber on the nozzle plate, a vibration plate on the flow channel substrate, and a piezoelectric element disposed on the vibration plate and including an upper electrode, a lower electrode, and a piezoelectric thin film between the upper and the lower electrode. The method includes forming a piezoelectric thin film by the above-described method.

This liquid ejection head manufacturing method has the same effects as the above method for forming a piezoelectric thin film.

According to still another aspect of the invention, a method is provided which manufactures a liquid ejection apparatus including a nozzle plate having a nozzle aperture, a flow channel substrate having a pressure generating chamber on the nozzle plate, a vibration plate on the flow channel substrate, and a piezoelectric element disposed on the vibration plate and including an upper electrode, a lower electrode, and a piezoelectric thin film between the upper and the lower electrode. The method includes forming a piezoelectric thin film by the above-described method.

This liquid ejection apparatus manufacturing method has the same effects as the above method for forming a piezoelectric thin film.

### BRIEF DESCRIPTION OF THE DRAWINGS

The invention will be described with reference to the accompanying drawings, wherein like numbers reference like elements.

FIG. 1 is a schematic representation of an ink jet recording apparatus.

FIG. 2 is an exploded perspective view of an ink jet recording head.

FIG. 3A is a fragmentary plan view of the ink jet recording head, and FIG. 3B is a sectional view taken along line IIIB-IIIB in FIG. 3A.

FIG. 4 is a flow chart of a method for forming a piezoelectric thin film.

FIGS. 5A to 5D are fragmentary sectional views of some steps of the method for forming the piezoelectric thin film.

### DESCRIPTION OF EXEMPLARY EMBODIMENTS

Embodiments of the invention will now be described in detail with reference to the drawings.

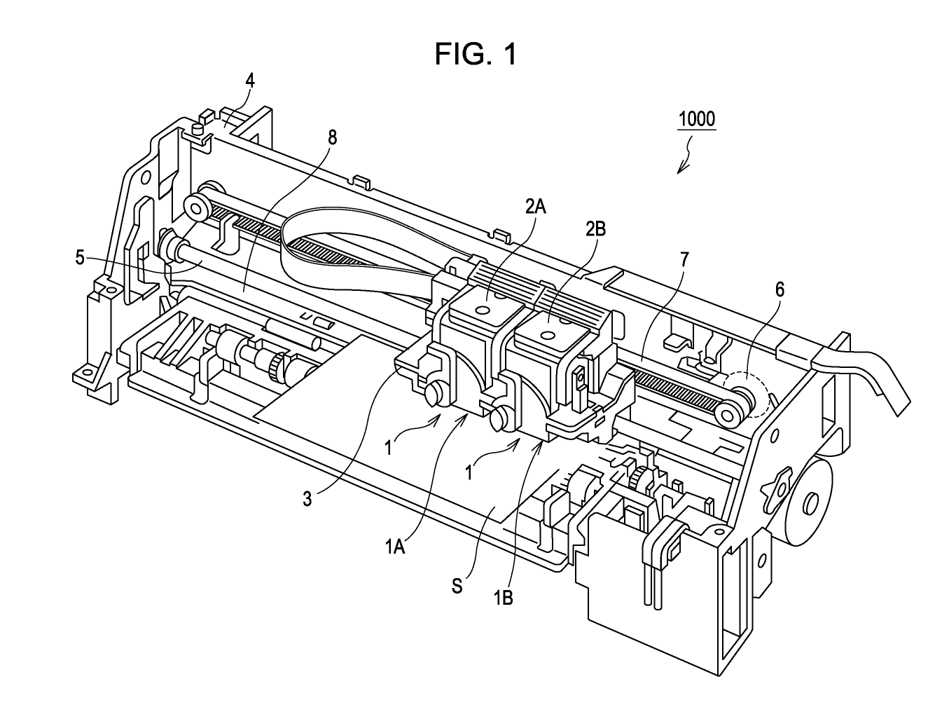

FIG. 1 is a schematic representation of an ink jet recording apparatus 1000 according to an embodiment of the invention, which is a form of a liquid ejection apparatus of the invention. The ink jet recording apparatus 1000 ejects ink onto a recording sheet S, or a recording medium, to record information, an image or the like.

The ink jet recording apparatus 1000 shown in FIG. 1 includes recording head units 1A and 1B, each including an ink jet recording head 1 being a liquid ejection head. The recording head units 1A and 1B respectively have removable cartridges 2A and 2B constituting an ink supply unit.

The ink jet recording heads 1 are disposed at the side of the recording head units 1A and 1B opposing the recording sheet S, and are not shown in FIG. 1.

A carriage 3 having the recording head units 1A and 1B is secured to a carriage shaft 5 fixed to a device body 4 for movement along the shaft 5. The recording head units 1A and 1B eject, for example, a black ink composition and a color ink composition, respectively.

The carriage 3 on which the recording head units 1A and 1B are mounted is moved along the carriage shaft 5 by transmitting a driving force from a driving motor 6 to the carriage 3 with a plurality of gears (not shown) and a timing belt 7.

The device body 4 is provided with a platen 8 along the carriage shaft 5. The platen 8 can be rotated by a driving force of a paper feed motor (not shown) so that a recording sheet S being a print medium, such as paper, fed with a paper feed roller or the like is transported over the platen 8.

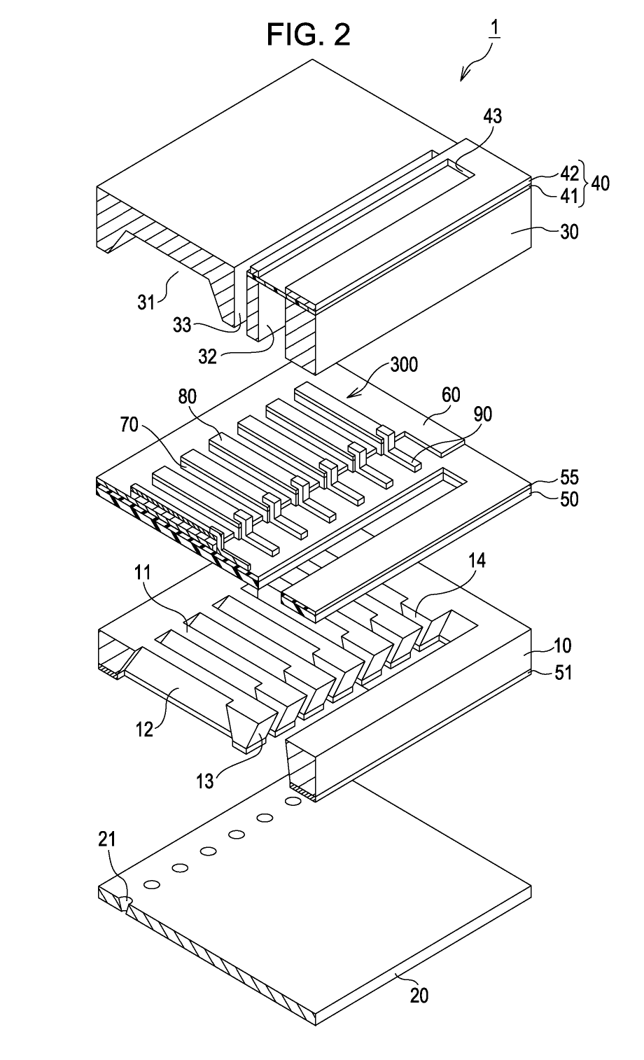

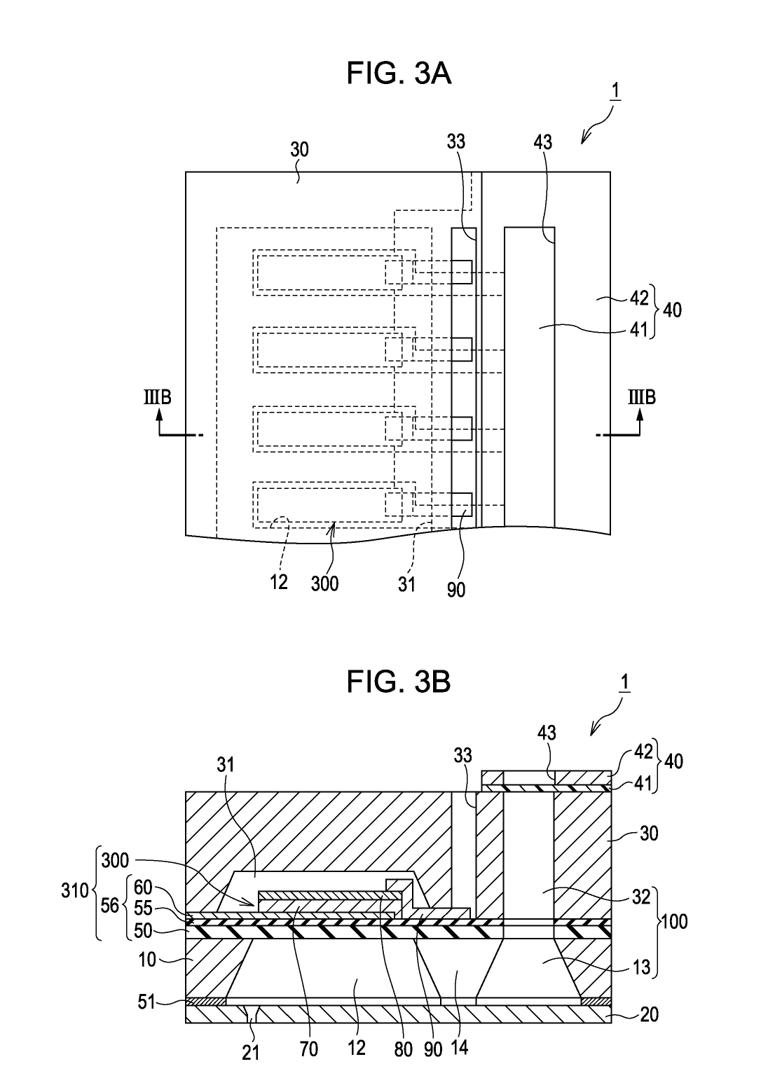

Turning now to FIG. 2 and FIGS. 3A and 3B, the ink jet recording head 1 will be described in detail.

FIG. 2 is a schematic exploded perspective view of the ink jet recording head 1. FIG. 3A is a fragmentary plan view of the ink jet recording head 1 and FIG. 3B is a sectional view taken along line IIIB-IIIB in FIG. 3A.

The ink jet recording head 1 shown in FIGS. 2 and 3A and 3B includes a flow channel substrate 10, a nozzle plate 20, and a protective substrate 30.

The flow channel substrate 10 may be made of (110) plane-oriented single crystal silicon, and a silicon oxide elastic film 50 has been formed in advance to a thickness of about 0.50 to 2.00 μm on one surface of the flow channel substrate 10 by thermal oxidation.

The flow channel substrate 10 has pressure generating chambers 12 separated by a plurality of partition members 11 so as to be arranged in parallel to each other. The pressure generating chambers 12 are formed by anisotropically etching the single crystal silicon substrate from the surface opposing the elastic film 50. In this etching, the elastic film 50 acts as an etching stopper.

A communicating section 13 is formed at one side of the pressure generating chambers 12 in the direction perpendicular to the arrangement (widths) of the pressure generating chambers 12 (in the longitudinal direction of the pressure generating chambers). The communicating section 13 communicates with the below-described reservoir section 32 of the protective substrate 30. The communicating section 13 also communicates with one ends of the respective pressure generating chambers 12 through ink supply channels 14.

A mask layer 51 used for forming the pressure generating chambers 12 is provided over the surface of the flow channel substrate 10 on the opposite side to the elastic film 50. The mask layer 51 is joined with the nozzle plate 20 with an adhesive, a thermal fusion film or the like therebetween. The nozzle plate 20 has nozzle apertures 21 communicating with the ends of the respective pressure generating chambers 12 opposite to the ink supply channels 14.

An insulating film 55 having a thickness of, for example, about 0.40 μm is formed on the surface of the elastic film 50 opposite to the flow channel substrate 10. On the insulating film 55, a lower electrode layer 60 having a thickness of, for example, about 0.20 μm, a piezoelectric thin film 70 having a thickness of, for example, about 1.30 μm, and an upper electrode layer 80 having a thickness of, for example, about 0.05 μm are formed for piezoelectric elements 300.

The piezoelectric element 300 mentioned herein refers to the portion including the lower electrode layer 60, the piezoelectric thin film 70 and the upper electrode layer 80. In general, either electrode of the piezoelectric element 300 acts as a common electrode, and the other electrode and the piezoelectric thin film 70 are formed for each pressure generating chamber 12 by patterning. The electrode and piezoelectric thin film 70 formed by patterning define a piezoelectric active portion at which piezoelectric distortion is caused by applying a current to both electrodes.

In the present embodiment, the lower electrode layer 60 acts as the common electrode of the piezoelectric elements 300 and the upper electrode layer 80 is formed into discrete electrodes of the piezoelectric elements 300. The functions of the lower and upper electrodes may be reversed depending on the driving circuit and the wiring. In either case, the piezoelectric active portion is provided for each pressure generating chamber 12. The piezoelectric element 300 and the portion deformed by the operation of the piezoelectric element 300 define a piezoelectric actuator 310.

In the present embodiment, the elastic film 50, the insulating film 55 and the lower electrode layer 60 constitute a vibration plate 56, that is, the portion deformed by the operation of the piezoelectric element 300. Alternatively, the vibration plate may be defined only by the lower electrode layer 60. In such a case, the piezoelectric element 300 acts as a piezoelectric actuator.

The protective substrate 30 has a piezoelectric element-protecting space 31 in the region opposing the piezoelectric elements 300 so that the piezoelectric elements 300 can operate without interference. The protective substrate 30 is bonded to the surface having the piezoelectric elements 300 of the flow channel substrate 10 with an adhesive. The piezoelectric elements 300 are thus disposed in the piezoelectric element-protecting space 31, consequently being protected in a state hardly affected by the external environment. The piezoelectric element-protecting space 31 may or may not be sealed.

The protective substrate 30 has a reservoir section 32 therein. The reservoir section 32 communicates with the communicating section 13 of the flow channel substrate 10 to define a reservoir 100 acting as a common ink chamber of the pressure generating chambers 12. In addition, a through hole 33 passes through the thickness of the protective substrate 30 between the piezoelectric element-protecting space 31 and the reservoir section 32. In the through hole 33, ends of respective lead electrodes 90 extracted from the piezoelectric elements 300 are exposed.

Furthermore, a compliance substrate 40 including a sealing film 41 and a fixing plate 42 is joined on the protective substrate 30. The fixing plate 42 is made of a hard material such as metal. The portion of the fixing plate 42 opposing the reservoir 100 is completely removed in the thickness direction to form an opening 43; hence the reservoir 100 is closed at one end only with the flexible sealing film 41.

The ink jet recording head 1 draws an ink from an external ink supply unit (not shown). The ink is delivered to fill the spaces from the reservoir 100 to the nozzle apertures 21. Then, the ink jet recording head 1 applies a voltage between the lower electrode layer 60 and the upper electrode layers 80 corresponding to the pressure generating chambers 12, according to the driving signal from a driving IC (not shown). Thus, the elastic film 50, the insulating film 55, the lower electrode layer 60 and the piezoelectric thin films 70 are deformed to increase the internal pressure in the pressure generating chambers 12, thereby ejecting the ink from the nozzle apertures 21.

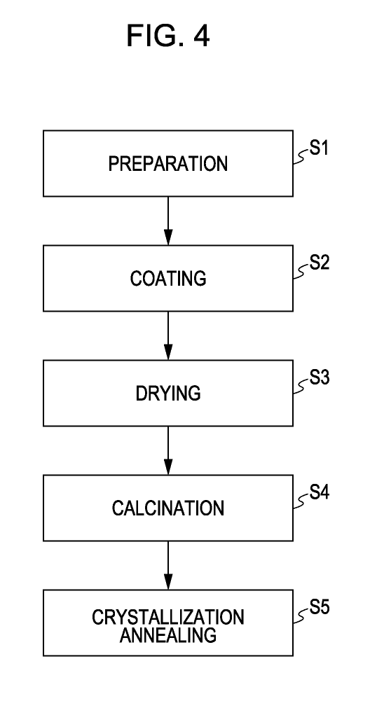

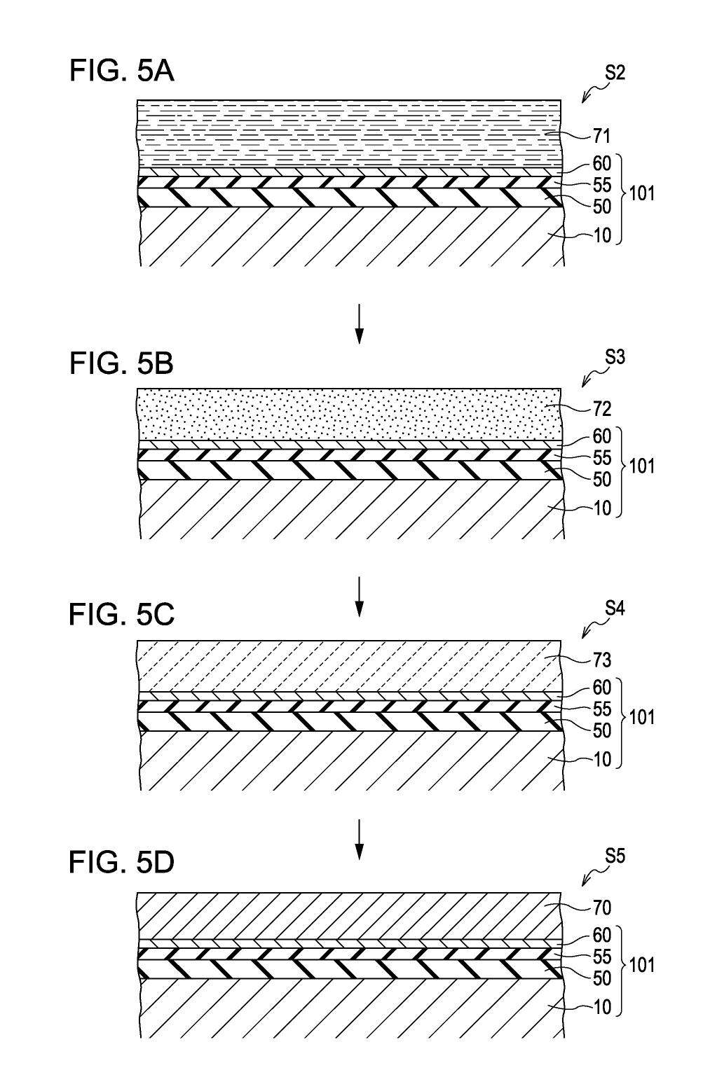

A method for forming the piezoelectric thin film 70 will now be described in detail. FIG. 4 is a flow chart of the method for forming the piezoelectric thin film 70. FIGS. 5A to 5D are fragmentary sectional views of some steps of the method. FIG. 5A shows a coating step (S2); FIG. 5B, a drying step (S3); FIG. 5C, a calcination step (S4); and FIG. 5D, a crystallization annealing step (S5).

The method for forming the piezoelectric thin film 70 shown in FIGS. 4 and 5A to 5D includes Step 1 (S1) being the preparation step of preparing a colloid solution 71, Step 2 (S2) being the coating step of applying the colloid solution 71 onto a substrate 101, Step 3 (S3) being the drying step of drying the colloid solution 71 to form a dried film 72, Step 4 (S4) being the calcination step of degreasing the dried film 72 to form an inorganic film 73, and Step 5 (S5) being the crystallization annealing step of crystallizing the inorganic film 73.

In the preparation step (S1), lead acetate, an organic metal compound, a carboxylic acid, and polyethylene glycol are mixed and stirred to prepare a colloid solution. The mixing may be performed in several steps. For example, the carboxylic acid used as a solvent and the organic metal compound may be mixed to prepare a first transparent precursor solution, and then, lead acetate and polyethylene glycol are added to and mixed with the solution to prepare a homogeneous second transparent precursor solution. This second solution can be used as the colloid solution.

The lead acetate may be trihydrate. The organic metal compound is not particularly limited. For example, a metal alkoxide or metal acetate containing Ti or Zr can be used for a PZT piezoelectric thin film 70. Examples of metal alkoxide include zirconium tetra-n-butoxide and titanium tetraisoproxide. Examples of metal acetate include zirconium acetate, titanium oxyacetate, and titanium acetate. The proportions of the metals in the lead acetate and the organic metal compound are not particularly limited. For example, a composition for forming a PZT thin film may contain lead acetate and an organic metal compound in proportions of Pb:Zr:Ti=1.0 to 1.2:0.46 to 0.56:0.44 to 0.54 (on a molar basis).

Preferably, the carboxylic acid is acetic acid, propionic acid or butyric acid in view of the boiling point, viscosity, solubility in water, and difficulty of gelation of the colloid solution. These carboxylic acids may be used singly or in combination.

Preferably, the polyethylene glycol has an average molecular weight of 300 to 1000. If the polyethylene glycol has an average molecular weight of less than 300, the occurrence of cracks in the dried film 72, the inorganic film 73 or the piezoelectric thin film 70 cannot be prevented sufficiently. On the other hand, if the polyethylene glycol has an average molecular weight of more than 1000, organic substances cannot be sufficiently decomposed by the calcination described below, and accordingly, many cavities are formed in the resulting piezoelectric thin film 70.

In the coating step (S2) shown in FIG. 5A, the colloid solution 71 is applied onto the substrate 101. The substrate to be coated is not particularly limited. In the present embodiment, the substrate 101 includes a flow channel substrate 10, and an elastic film 50, an insulating film 55 and a lower electrode layer 60 formed on the flow channel substrate 10. The lower electrode layer 60 is formed into a desired shape by patterning.

Various techniques can be applied to the coating step without particular limitation. If a uniform coating is formed on one side of a substrate, spin coating is preferable. The conditions for spin coating depend on the viscosity of the colloid solution 71 and the relative evaporation rate of the carboxylic acid. For example, the spin rate can be set at 500 to 4000 rpm, and the coating time may be adjusted according to the desired thickness.

If the colloid solution 71 contains two or more carboxylic acids, it is preferable that the carboxylic acids have viscosities of 1.8 cps or less and boiling points of 163° C. or less. The colloid solution having properties in those ranges can form a thick coating.

FIG. 5B shows the drying step (S3). The conditions for the drying step depend on the solvent or carboxylic acid to be used, and are not particularly limited. For example, the drying step may be performed at a temperature of 100 to 150° C. for several minutes. The drying step performed at a temperature of 150° C. or less can prevent the polyethylene glycol and metal ligands from being decomposed by thermal oxidation. This step can be performed under conditions where most or all of the solvent, or the carboxylic acid, will be evaporated.

Turning to FIG. 5C, the calcination step (S4) is performed for degreasing until substantially all the organic components in the dried film 72 are removed. The calcination conditions depend on the type of the organic metal compound. For a metal alkoxide or a metal acetate, the calcination is performed at about 400° C. for several minutes. For example, the calcination may be performed in an electric furnace in the atmosphere. The inorganic film 73 formed in this step may contain an organic residue.

In the crystallization annealing step (S5) shown in FIG. 5D, the inorganic film 73 formed in the calcination step S4 is crystallized. The crystallization annealing conditions depend on the intended piezoelectric thin film 70. If a PZT piezoelectric thin film 70 is formed, the crystallization annealing step is performed at a temperature of 650 to 750° C. for several minutes. Preferably, this step is performed in an oxygen atmosphere or an oxygen flow to prevent lack of oxygen in the crystal. Carbon may remain in the crystal.

If the film formed through a sequence of the above steps does not have a desired thickness, the sequence of the steps is repeated until the desired thickness is obtained. The piezoelectric thin film 70 having a desired thickness is thus formed in layers. Then, upper electrode layers 80, lead electrodes 90 and others are formed on the wafer of the substrate 101 on which the piezoelectric thin film 70 has been formed, and the resulting wafer is divided into a plurality of ink jet recording heads 1, piezoelectric elements 300 and piezoelectric actuators 310.

The above-described embodiment produces the flowing effects:

(1) Since the carboxylic acid acts as a solvent and a stabilizing agent, the ratio of the carboxylic acid to the lead acetate and organic metal compound can be reduce to increase the concentration of the lead acetate and organic metal compound in the colloid solution 71. The high-concentration colloid solution 71 can form a thick piezoelectric thin film 70 through a sequence of the coating step (S2) of applying the colloid solution 71, the drying step (S3) of drying the colloid solution to form a dried film, the calcination step (S4) of degreasing the dried film to form an inorganic film, and the crystallization annealing step (S5) of crystallizing the inorganic film. Accordingly, the number of sequences of the steps for forming a film having a desired thickness can be reduced, and the productivity can thus be increased. Thus, the piezoelectric thin film 70 can be formed at a low const.

(2) Metal alkoxide is soluble in carboxylic acid, and this solution can be applied to form a coating. The carboxylic acid can coordinate to the metallic element of the metal alkoxide to exhibit a stabilization effect. Accordingly, a metal oxide coating can easily be formed. A solution of lead acetate and a metal alkoxide in the carboxylic acid can easily produce a complex metal oxide containing lead.

(3) A PZT film can be formed at a reduced cost.

(4) Carboxylic acids such as acetic acid, propionic acid, and butyric acid, have high solubilities in water, and accordingly can prevent the production of hydrolysates. In addition, the use of these carboxylic acids allows easy coating and rapid dry because of their low viscosities and low boiling points. Consequently, the resulting piezoelectric thin film can have a larger thickness. Accordingly, the number of the steps for forming a film having a desired thickness can be further reduced, and the productivity can be further increased. Thus, the piezoelectric thin film 70 can be formed at a still lower cost.

(5) Carboxylic acids are less toxic to the human body than cellosolves represented by methoxy ethanol. Accordingly, the use of such a carboxylic acid can provide a safer method for forming a piezoelectric thin film 70.

(6) A piezoelectric element 300, a piezoelectric actuator 310, an ink jet recording head 1 and an ink jet recording apparatus 1000 are produced safely at low cost.

The embodiment of the invention will be further described in detail with reference to Examples. In the Examples and Comparative Example described below, the preparation step differed to prepare different colloid solutions, and the coating step, the drying step, the calcination step, and the crystallization annealing step were performed under the same conditions. The preparation step of the colloid solution for each Example or Comparative Example will first be described, and then the other steps will be described.

### Preparation Step

### Example 1

First, 0.31 mol of zirconium tetra-n-butoxide (purity 85.0% to 90.0%, containing 10.0% to 15.0% of 1-butanol, available from Kanto Kagaku) and 0.29 mol of titanium tetraisopropoxide (purity>97.0%, available from Kanto Kagaku) were added to 400 g of acetic acid (solvent, purity>99.7%, available from Kanto Kagaku). The mixture was stirred for about one hour to prepare a homogeneous first transparent precursor solution.

Subsequently, 0.71 mol of lead acetate trihydrate (purity>99.5%, available from Kanto Kagaku) and 70 g of polyethylene glycol (available from Kanto Kagaku) were added to the first transparent precursor solution. The mixture was heated at about 80° C. for about 4 hours with stirring to yield a homogeneous second transparent precursor solution. This solution was used as the colloid solution for forming PZT films. In Example 1, the polyethylene glycol had an average molecular weight of 600.

The metal component content in the colloid solution was 22.4% by weight on an oxide basis (in terms of metal oxides: lead oxide PbO, zirconium oxide ZrO₂ and titanium oxide TiO₂).

### Example 2

The colloid solution for forming PZT films was prepared in the same manner as in Example 1, except that the amount of acetic acid was increased to 500 g. The metal component content in the colloid solution was 20.8% by weight on an oxide basis (in terms of metal oxides: lead oxide PbO, zirconium oxide ZrO₂, and titanium oxide TiO₂).

### Example 3

First, 0.31 mol of zirconium tetra-n-butoxide and 0.29 mol of titanium tetraisopropoxide were added to 370 g of propionic acid (solvent, purity>99.3%, available from Kanto Kagaku). The mixture was stirred for about one hour to prepare a homogeneous first transparent precursor solution.

Subsequently, 0.71 mol of lead acetate trihydrate and 70 g of polyethylene glycol were added to the first transparent precursor solution. The mixture was heated at about 80° C. for about 4 hours with stirring to yield a homogeneous second transparent precursor solution. This solution was used as the colloid solution for forming PZT films. In Example 3 as well, the polyethylene glycol had an average molecular weight of 600.

The metal component content in the colloid solution was 23.8% by weight on an oxide basis (in terms of metal oxides: lead oxide PbO, zirconium oxide ZrO₂ and titanium oxide TiO₂).

### Example 4

The colloid solution for forming PZT films was prepared in the same manner as in Example 3, except that the amount of propionic acid was increased to 430 g. The metal component content in the colloid solution was 22.4% by weight on an oxide basis (in terms of metal oxides: lead oxide PbO, zirconium oxide ZrO₂, and titanium oxide TiO₂).

### Example 5

First, 0.31 mol of zirconium tetra-n-butoxide and 0.29 mol of titanium tetraisopropoxide were added to 340 g of n-butyric acid (solvent, purity>99.5%, available from Kanto Kagaku). The mixture was stirred for about one hour to prepare a homogeneous first transparent precursor solution.

Subsequently, 0.71 mol of lead acetate trihydrate and 70 g of polyethylene glycol as a crack inhibitor were added to the first transparent precursor solution. The mixture was heated at about 80° C. for about 4 hours with stirring to yield a homogeneous second transparent precursor solution. This solution was used as the colloid solution for forming PZT films. In Example 5 as well, the polyethylene glycol had an average molecular weight of 600.

The metal component content in the colloid solution was 24.5% by weight on an oxide basis (in terms of metal oxides: lead oxide PbO, zirconium oxide ZrO₂ and titanium oxide TiO₂).

### Example 6

The colloid solution for forming PZT films was prepared in the same manner as in Example 5, except that the amount of n-butyric acid was increased to 430 g. The metal component content in the colloid solution was 22.4% by weight on an oxide basis (in terms of metal oxides: lead oxide PbO, zirconium oxide ZrO₂, and titanium oxide TiO₂).

### Comparative Example

First, 150 g of diethanolamine (purity>99.0%, available from Kanto Kagaku) and 0.29 mol of titanium tetraisopropoxide were added to 700 g of 2-n-butoxyethanol (solvent, purity>98.0%, available from Kanto Kagaku). The mixture was stirred for about one hour to prepare a homogeneous first transparent precursor solution.

Subsequently, 0.72 mol of lead acetate trihydrate and 0.31 mol of zirconium acetylacetonato (available from Tokyo Chemical Industry) were added to the first transparent precursor solution. The mixture was heated at about 80° C. for about 4 hours with stirring to yield a homogeneous second transparent precursor solution.

Finally, 70 g of polyethylene glycol as a crack inhibitor was further added to the second transparent precursor solution, and the mixture was stirred for about one hour to yield a homogeneous third transparent precursor solution. This solution was used as the colloid solution for forming PZT films. In the Comparative Example, the polyethylene glycol had an average molecular weight of 400.

The metal component content in the colloid solution was 15.5% by weight on an oxide basis (in terms of metal oxides: lead oxide PbO, zirconium oxide ZrO₂ and titanium oxide TiO₂).

### Coating Step

Coatings of the colloid solutions of the Examples and the Comparative Example were formed by spin coating. The spin coating was performed at a rotation rate of 2000 rpm for 60 seconds.

### Drying Step

The coatings were dried by heat treatment at about 140° C. for about 5 minutes.

### Calcination Step

In the calcination step, heat treatment was performed at about 400° C. for about 5 minutes.

### Crystallization Annealing Step

In the crystallization annealing step, heat treatment was performed at about 700° C. for about 5 minutes with oxygen flow.

The section of the resulting piezoelectric thin film was observed through a scanning microscope to measure the thickness. The thickness measurements of the Examples and Comparative Example are shown in the Table.

TABLE

| | | Metal | | |
|---|---|---|---|---|
| | | component | | |
| | | content | Rotation | Thickness |
| | Solvent | (wt %) | rate (rpm) | (nm) |
| Example 1 | Acetic acid 400 g | 22.4 | 2000 | 310 |
| Example 2 | Acetic acid 500 g | 20.8 | 2000 | 272 |
| Example 3 | Propionic acid 370 g | 23.8 | 2000 | 260 |
| Example 4 | Propionic acid 430 g | 22.4 | 2000 | 236 |
| Example 5 | n-Butyric acid 340 g | 24.5 | 2000 | 300 |
| Example 6 | n-Butyric acid 430 g | 22.4 | 2000 | 224 |
| Comparative | 2-n-Butoxyethanol | 15.5 | 2000 | 90 |
| Example | 700 g | | | |

It was confirmed that the piezoelectric thin films of the Examples formed by a single sequence of the above-described steps had larger thicknesses than the piezoelectric thin film of the Comparative example. For example, for a piezoelectric thin film of about 1.30 μm in thickness, the comparative example must repeat the step sequence more than ten times while the method of the above embodiment will perform the step sequence only several times.

In addition, while the piezoelectric thin film of the Comparative Example exhibited a roughness height of about 50 nm, the Examples reduced the roughness height of the piezoelectric thin film to about 10 nm.

In both of the Examples and the Comparative Example, cracks were prevented during film formation. This is an effect of the addition of polyethylene glycol.

There are no large differences between the Examples and the Comparative Example in other properties of the resulting piezoelectric thin films, such as crystallinity (θ/2θ measurement by X-ray diffraction), P-V hysteresis, piezoelectric displacement, and pulse endurance test results (displacement after applying about 20 billion pulses and hysteresis).

Furthermore, the precursor solutions of the Examples and the Comparative Example did not cause precipitation even though 40% by volume of water was added. All the precursor solutions were stable during storage.

The various modifications may be made in the above-described embodiment. For example, the method for forming the piezoelectric thin film 70 may include a rinsing step to remove the colloid solution 71 on the periphery and rear surface of the wafer. The method of the above embodiment may be applied to a process for forming a TiO₂ or a ZrO₂ dielectric thin film.

Although the above embodiment has described an ink jet recording head as the liquid ejection head, the invention is intended for any type of liquid ejection head, and may be applied to other liquid ejection heads ejecting liquid other than ink. Other liquid ejection heads include various types of recording head used in image recording apparatuses such as printers, color material ejecting heads used for manufacturing color filters of liquid crystal displays or the like, electrode material ejecting heads used for forming electrodes of organic EL displays or FEDs (field emission displays), and bioorganic material ejecting heads used for manufacturing bio-chips.

The piezoelectric thin film 70 formed of the above-described colloid solution 71 can be widely applied to the device development without particular limitation. For example, it can be used for micro actuators, filters, delay lines, lead selectors, tuning fork oscillators, tuning fork clocks, transceivers, piezoelectric pickups, piezoelectric earphones, piezoelectric microphones, SAW filters, RF modulators, resonators, delay elements, multistrip couplers, piezoelectric accelerometers, and piezoelectric speakers.

What is claimed is:

1. A method for forming a piezoelectric thin film comprising:
applying a colloid solution onto a substrate, the colloid solution containing lead acetate as a material of lead oxide, an organic metal compound as a material of metal oxides other than lead oxide, a carboxylic acid, and polyethylene glycol;
forming a dried film by drying the colloid solution;
forming an inorganic film by degreasing the dried film; and
crystallizing the inorganic film.

2. The method according to claim 1, wherein the organic metal compound is a metal alkoxide.

3. The method according to claim 2, wherein the metal alkoxide contains at least one of Ti and Zr.

4. The method according to claim 1, wherein the carboxylic acid is at least one selected from the group consisting of acetic acid, propionic acid and butyric acid.

5. A method for manufacturing a liquid ejection head including a nozzle plate having a nozzle aperture, a flow channel substrate having a pressure generating chamber on the nozzle plate, a vibration plate on the flow channel substrate, and a piezoelectric element disposed on the vibration plate and including an upper electrode, a lower electrode, and a piezoelectric thin film between the upper and the lower electrode, the method comprising:
forming a piezoelectric thin film, including:
applying a colloid solution onto a substrate, the colloid solution containing lead acetate as a material of lead oxide, an organic metal compound as a material of metal oxides other than lead oxide, a carboxylic acid, and polyethylene glycol;
forming a dried film by drying the colloid solution;
forming an inorganic film by degreasing the dried film; and
crystallizing the inorganic film.

6. The method according to claim 5, wherein the organic metal compound is a metal alkoxide.

7. The method according to claim 6, wherein the metal alkoxide contains at least one of Ti and Zr.

8. The method according to claim 5, wherein the carboxylic acid is at least one selected from the group consisting of acetic acid, propionic acid and butyric acid.

9. A method for manufacturing a liquid ejecting apparatus including a nozzle plate having a nozzle aperture, a flow channel substrate having a pressure generating chamber on the nozzle plate, a vibration plate on the flow channel substrate, and a piezoelectric element disposed on the vibration plate and including an upper electrode, a lower electrode, and a piezoelectric thin film between the upper and the lower electrode, the method comprising:
forming a piezoelectric thin film, including:
applying a colloid solution onto a substrate, the colloid solution containing lead acetate as a material of lead oxide, an organic metal compound as a material of metal oxides other than lead oxide, a carboxylic acid, and polyethylene glycol;
forming a dried film by drying the colloid solution;
forming an inorganic film by degreasing the dried film; and
crystallizing the inorganic film.

10. The method according to claim 9, wherein the organic metal compound is a metal alkoxide.

11. The method according to claim 10, wherein the metal alkoxide contains at least one of Ti and Zr.

12. The method according to claim 9, wherein the carboxylic acid is at least one selected from the group consisting of acetic acid, propionic acid and butyric acid.
